(19) United States
(12) Patent Application Publication
(10) Pub. No.: US 2025/0358615 A1
(43) Pub. Date: Nov. 20, 2025

(54) TRACKING-RESISTANT CLIENT INDICATION USING BLOOM FILTERS

(71) Applicant: QUALCOMM Incorporated, San Diego, CA (US)

(72) Inventors: Philip Michael HAWKES, Valley Heights (AU); Sai Yiu Duncan HO, San Diego, CA (US); Jouni Kalevi MALINEN, Tuusula (FI)

(21) Appl. No.: 18/664,192

(22) Filed: May 14, 2024

(51) Int. Cl. H04W 12/069; H04W 24/08; H04W 52/02

(52) U.S. Cl. CPC H04W 12/069; H04W 24/08; H04W 52/0261

(57) ABSTRACT

This disclosure provides methods, components, devices and systems for tracking-resistant client indication using bloom filters. Some aspects more specifically relate to improving privacy and security in a network by introducing a secret-based probabilistic technique for client device identification. In some examples, a first device may establish one or more authentication keys with one or more second devices, may generate a broadcast data object using a bloom filter, and may transmit the data object. The data object may indicate a bloom filter output indicating to one or more of the second devices to monitor for data transmissions. A second device that receives the data object and the bloom filter output may monitor for data transmissions based on comparing a set of bit positions, corresponding to the second device, to bits in the bloom filter output, where the set of bit positions may be based on the authentication key.

### TECHNICAL FIELD

This disclosure relates generally to wireless communication and, more specifically, to tracking-resistant client indication using bloom filters.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a first wireless communication device is described. The method may include establishing an authentication key with a second wireless communication device, receiving a data object via one or more channels indicating a bloom filter output, and monitoring for a data transmission based on a comparison between a set of bit positions and the bloom filter output, the set of bit positions being based on the authentication key, and the comparison indicating that the first wireless communication device is to monitor for the data transmission.

Another innovative aspect of the subject matter described in this disclosure can be implemented in a first wireless communication device for wireless communications is described. The first wireless communication device may include a processing system that includes processor circuitry and memory circuitry that stores code. The processing system may be configured to cause the first wireless communication device to establish an authentication key with a second wireless communication device, receive a data object via one or more channels indicating a bloom filter output, and monitor for a data transmission based on a comparison between a set of bit positions and the bloom filter output, the set of bit positions being based on the authentication key, and the comparison indicating that the first wireless communication device is to monitor for the data transmission.

Another innovative aspect of the subject matter described in this disclosure can be implemented in another first wireless communication device for wireless communications. The first wireless communication device may include means for establishing an authentication key with a second wireless communication device, means for receiving a data object via one or more channels indicating a bloom filter output, and means for monitoring for a data transmission based on a comparison between a set of bit positions and the bloom filter output, the set of bit positions being based on the authentication key, and the comparison indicating that the first wireless communication device is to monitor for the data transmission.

Another innovative aspect of the subject matter described in this disclosure can be implemented in a non-transitory computer-readable medium storing code for wireless communications is described. The code may include instructions executable by one or more processors to establish an authentication key with a second wireless communication device, receive a data object via one or more channels indicating a bloom filter output, and monitor for a data transmission based on a comparison between a set of bit positions and the bloom filter output, the set of bit positions being based on the authentication key, and the comparison indicating that the first wireless communication device is to monitor for the data transmission.

Some examples of the method, first wireless communication devices, and non-transitory computer-readable medium described herein may further include operations, features, means, or instructions for generating a bloom filter input associated with the first wireless communication device based on the authentication key and a randomization value, where the set of bit positions may be based on the bloom filter input, a bloom filter size, and a quantity of hash functions.

Some examples of the method, first wireless communication devices, and non-transitory computer-readable medium described herein may further include operations, features, means, or instructions for receiving the randomization value via the data object, via a separate message, or both.

Some examples of the method, first wireless communication devices, and non-transitory computer-readable medium described herein may further include operations, features, means, or instructions for receiving a data transmission based on the monitoring.

Some examples of the method, first wireless communication devices, and non-transitory computer-readable medium described herein may further include operations, features, means, or instructions for terminating the monitoring based on failure to receive the data transmission and entering a power saving mode based on the terminating.

In some examples of the method, first wireless communication devices, and non-transitory computer-readable medium described herein, the data object indicates a bloom filter size, a quantity of hash functions, or both, where the set of bit positions may be based on the bloom filter size, the quantity of hash functions, or both.

In some examples of the method, first wireless communication devices, and non-transitory computer-readable medium described herein, the comparison indicates that the first wireless communication device is to monitor for the data transmission by indicating that the first wireless communication device may have a non-zero probability of being associated with one or more pending data transmissions.

Some examples of the method, first wireless communication devices, and non-transitory computer-readable medium described herein may further include operations, features, means, or instructions for receiving a second data object including a second bloom filter output and determining not to monitor for a second data transmission based on a second comparison between a second set of bit positions and the second bloom filter output, the second set of bit positions being based on the authentication key, and the second comparison indicating that the first wireless communication device may have a zero probability of being associated with the second data transmission.

In some examples of the method, first wireless communication devices, and non-transitory computer-readable medium described herein, the data object may be a broadcast data object identifying which of a set of multiple first wireless communication devices, including the first wireless communication device, is to monitor for data transmission. In some examples of the method, first wireless communication devices, and non-transitory computer-readable medium described herein, the first wireless communication device includes a station (STA) and the second wireless communication device includes an access point (AP).

One innovative aspect of the subject matter described in this disclosure can be implemented in a method for wireless communications by a second wireless communication device. The method may include transmitting a data object via one or more channels indicating a bloom filter output, the bloom filter output indicating that one or more first wireless communication devices of a set of multiple first wireless communication devices is to monitor for data transmission and transmitting one or more data transmissions associated with the one or more first wireless communication devices based on the data object.

Another innovative aspect of the subject matter described in this disclosure can be implemented in a second wireless communication device for wireless communications. The second wireless communication device may include a processing system that includes processor circuitry and memory circuitry that stores code. The processing system may be configured to cause the second wireless communication device to transmit a data object via one or more channels indicating a bloom filter output, the bloom filter output indicating that one or more first wireless communication devices of a set of multiple first wireless communication devices is to monitor for data transmission and transmit one or more data transmissions associated with the one or more first wireless communication devices based on the data object.

Another innovative aspect of the subject matter described in this disclosure can be implemented in another second wireless communication device for wireless communications. The second wireless communication device may include means for transmitting a data object via one or more channels indicating a bloom filter output, the bloom filter output indicating that one or more first wireless communication devices of a set of multiple first wireless communication devices is to monitor for data transmission and means for transmitting one or more data transmissions associated with the one or more first wireless communication devices based on the data object.

Another innovative aspect of the subject matter described in this disclosure can be implemented in a non-transitory computer-readable medium storing code for wireless communications. The code may include instructions executable by one or more processors to transmit a data object via one or more channels indicating a bloom filter output, the bloom filter output indicating that one or more first wireless communication devices of a set of multiple first wireless communication devices is to monitor for data transmission and transmit one or more data transmissions associated with the one or more first wireless communication devices based on the data object.

Some examples of the method, second wireless communication devices, and non-transitory computer-readable medium described herein may further include operations, features, means, or instructions for establishing a set of multiple authentication keys with the set of multiple first wireless communication devices and generating one or more respective bloom filter inputs associated with the one or more first wireless communication devices based on one or more respective authentication keys of the set of multiple authentication keys and one or more respective randomization values, where the bloom filter output may be based on the one or more respective bloom filter inputs, a bloom filter size, and a quantity of hash functions.

Some examples of the method, second wireless communication devices, and non-transitory computer-readable medium described herein may further include operations, features, means, or instructions for transmitting the one or more respective randomization values via the data object, via one or more separate messages, or both.

In some examples of the method, second wireless communication devices, and non-transitory computer-readable medium described herein, the bloom filter output includes one or more bit positions that may be set to a value of 1 and that may be different than one or more additional bit positions that may be set to the value of 1 based on the one or more respective bloom filter inputs, the quantity of hash functions, and one or more randomized bit values.

Some examples of the method, second wireless communication devices, and non-transitory computer-readable medium described herein may further include operations, features, means, or instructions for selecting one or more bloom filter parameters, where a bloom filter size and a quantity of hash functions may be based on the one or more bloom filter parameters.

In some examples of the method, second wireless communication devices, and non-transitory computer-readable medium described herein, the bloom filter size may be greater than a second bloom filter size associated with the one or more first wireless communication devices.

In some examples of the method, second wireless communication devices, and non-transitory computer-readable medium described herein, the data object indicates a bloom filter size, a quantity of hash functions, or both.

In some examples of the method, second wireless communication devices, and non-transitory computer-readable medium described herein, the data object may be a broadcast data object identifying which of the set of multiple first wireless communication devices is to monitor for data transmission. In some examples of the method, second wireless communication devices, and non-transitory computer-readable medium described herein, the one or more first wireless communication devices include one or more stations (STA) and the second wireless communication device includes an AP.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example of a signaling diagram that supports tracking-resistant client indication using bloom filters.

FIG. 4 shows an example of a flowchart that supports tracking-resistant client indication using bloom filters.

FIGS. 5A, 5B, and 5C show examples of comparison operations that supports tracking-resistant client indication using bloom filters.

FIG. 6 shows an example of a process flow that supports tracking-resistant client indication using bloom filters.

FIG. 7 shows a block diagram of an example wireless communication device that supports tracking-resistant client indication using bloom filters.

FIG. 8 shows a block diagram of an example wireless communication device that supports tracking-resistant client indication using bloom filters.

FIG. 9 shows a flowchart illustrating an example process performable by or at a first wireless communication device that supports tracking-resistant client indication using bloom filters.

FIG. 10 shows a flowchart illustrating an example process performable by or at a second wireless communication device that supports tracking-resistant client indication using bloom filters.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

In some wireless communication networks, such as Wi-Fi systems, devices may implement communication protocols that may involve device identifiers. For example, a client device, such as a wireless station (STA) or non-AP multi-link device (MLD), may establish a connection with a broadcasting device of a network, such as an access point (AP) or AP MLD. After or during establishment of a connection (such as associating with an AP), the client device may be assigned one or more identifiers, such as a medium access control (MAC) address. A set of connected clients also may be identified via a broadcast traffic indication map (TIM), which may be broadcast within a beacon frame of a network. For example, the broadcasting device may, at connection, assign a bit within a total TIM bitstream (such as set of 1024 bits) to indicate if a device has traffic pending, enabling multiple devices to identify pending traffic using a single broadcast message. However, MAC addresses and TIMs, among other deterministic methods, may reveal information about connected clients (such as whether a client device is still connected within a network), allowing other devices in a network to identify and track the device, which may provide risks to security and reduce privacy.

Various aspects relate generally to tracking-resistant client indication using bloom filters. Some aspects more specifically relate to improving privacy and security by introducing a secret-based probabilistic technique for client device identification (such as using bloom filters). For example, a first device (such as a broadcaster, an AP) may establish one or more authentication keys with one or more second devices (such as a client, a STA), may generate a broadcast data object using a bloom filter, and may transmit the data object to the one or more second devices. In some examples, the data object may indicate a bloom filter output indicating to one or more of the second devices to monitor for data transmissions. For example, a second device that receives the bloom filter output may monitor for data transmissions by comparing a set of bit positions corresponding to the second device to bits in the bloom filter output, where the set of bit positions may be based on the authentication key.

In some examples, implementing a secret-based probabilistic approach, such as using a bloom filter, may prevent identification or tracking of one or more devices in a network. For example, a spying device may be unaware of which of the set of bit positions corresponds to a device as the bit positions may be based on secret keys and may indicate a probability, rather than a certainty, that a device is in a set. Additionally, utilizing bloom filters may support a variable size data structure for data objects, enabling broadcast traffic indications to a variety of quantities of clients in a network, while a probabilistic nature of the bloom filter may increase an efficiency in communications (such as by indicating a set of devices with traffic rather than a set of connected devices). Further, randomized values may be used to generate bloom filter outputs, which may further prevent tracking by altering unique bit locations at different times. Additionally, or alternatively, one or more false values may be used in bloom filter generation, such as a false set size for a set of devices with pending traffic, which may hide aspects of one or more devices in a network to improve privacy.

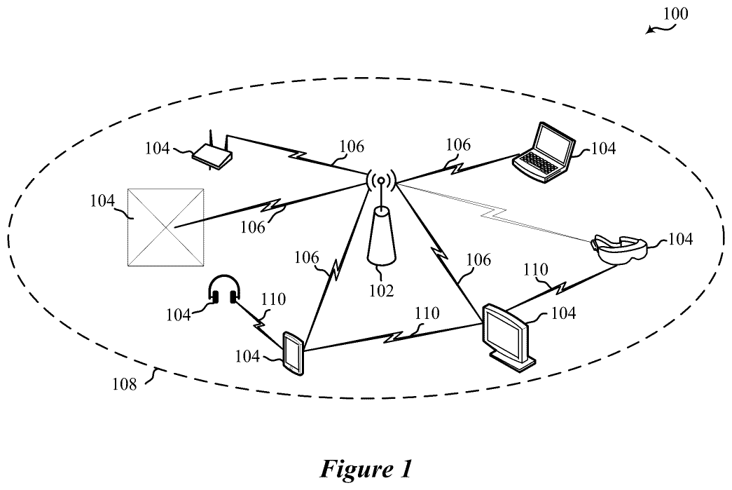

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a MAC address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHZ-52.6 GHz), FR3 (7.125 GHZ-24.25 GHz), FR4a or FR4-1 (52.6 GHz-71 GHz), FR4 (52.6 GHz-114.25 GHz), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

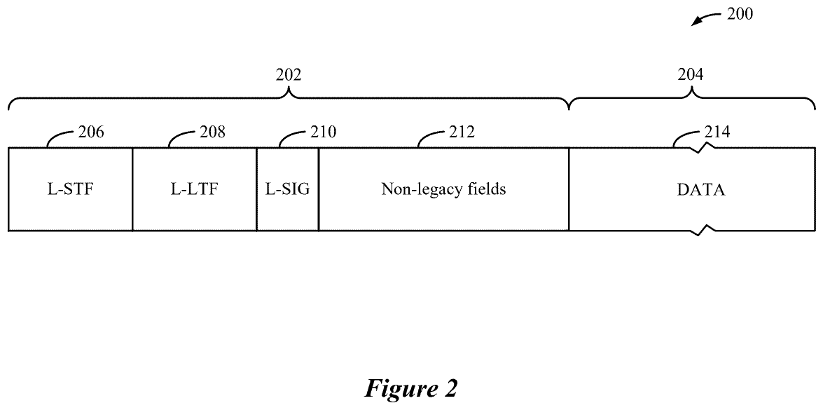

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

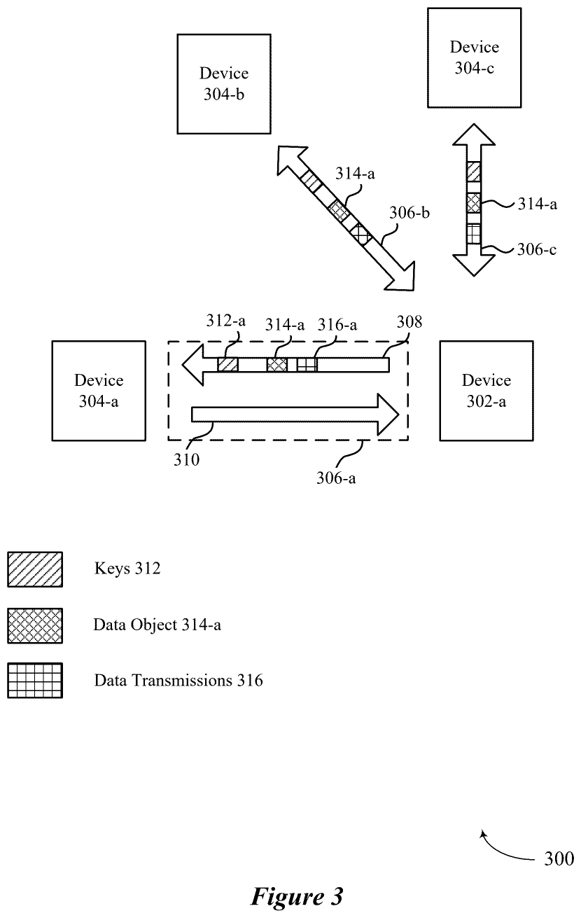

FIG. 3 shows a signaling diagram 300 that supports tracking-resistant client indication using bloom filters. Aspects of the signaling diagram 300 may implement, or be implemented by, aspects of the wireless communication network 100 and the PDU 200 as described herein with reference to FIGS. 1 and 2. For example, the signaling diagram 300 may include one or more devices 302, such as a device 302-a, which may be in communication with one or more devices 304. For example, the device 302-a may be in communication with a device 304-a via a communication link 306-a (including a downlink communication link 308 and an uplink communication link 310), and with a device 304-b and a device 304-c via communication links 306-b and 306-c, respectively. In some examples, a device 302 may be an example of a broadcasting device while a device 304 may be an example of a client (such as a client device). For example, the wireless communication network may be an example of a Wi-Fi network, where the device 302-a may be an AP 102 and the device 304-a may be a STA 104. Additionally, or alternatively, a device 302 may be an example of an AP multi-link device (MLD) in multi-link operation (MLO), while the device 304-a may be an example of a non-AP MLD. In some examples, the device 302-a and the device 304-a may support tracking-resistant client indication using bloom filters as described herein.

In some examples, the device 302-a may assign one or more identifiers as devices 304 become connected. For example, the device 304-a (such as a client, a STA) may join a network and may connect (such as associate) with the device 302-a (such as a broadcaster, an AP) using one or more communication protocols. In some examples, based on connecting with the device 302-a, the device 302-a may be assigned a unique MAC address, which may identify the device 302-a. In some examples, the device 304-a may utilize a same MAC address throughout multiple connected sessions. For example, after disconnecting from the network (such as a user with the device physically moves away), and reconnecting with the network, the device 304-a may reuse a same MAC address as in a previous session.

Additionally, or alternatively, devices 304 may be identified by a TIM element in a broadcast beacon field. For example, in a broadcast message is sent by the device 302-a, a TIM may identify a subset S of devices 304 associated to the device 302-a for which traffic is pending and buffered in the device 302-a (such as may indicate a subset of STAs or non-AP MLDs with traffic pending and buffered at an AP or AP MLD at a time that the broadcast message is sent). In some examples, a TIM may be, for example, a bit array for a quantity of devices that is computed from a unique AID assigned to each device 304 by the device 302-a at association, where a bit within the bit array may correspond to the device 304-a. In some examples, a total quantity of associated devices 304 may be limited by a size of a corresponding AID (such as in bits). In an example, the device 304 may monitor for such a message intermittently while in a power saving mode (such as a sleep mode, a sleep state). If the device 304 is in the set S (such as the specific bit is set to a value of ‘1’), the device 304-a may enter an active mode (such as wake up) to receive the traffic via one or more data transmission, otherwise the device 304-a may re-enter the power saving mode (such as re-enter a sleep mode, go back to sleep).

Identifiers, including MAC addresses and TIMs, may in some examples compromise the security and privacy of one or more devices 304. For example, by using a same MAC address during multiple connected sessions, a device 304-a may reveal its presence within a network and whether it leaves or rejoins. For example, a TIM may represent a deterministic identification method, and so may indicate a relatively reliable conclusion of whether a device is within a network. Thus, the set S of devices may be determined (such as trially, through experimentation) by another device 304 that receives a broadcasted TIM, such as the device 304-b, allowing a presence of the device 304-a to be tracked.

As described herein, a network may support one or more methods for tracking-resistant traffic indications and identification within a network. For example, a TIM replacement may be implemented to provide confidentiality. In some examples, such a replacement may involve a probabilistic mechanism (such as provided a STA with pending traffic refrains from going back to sleep). For example, a method may be utilized in which a device 304-a may determine that it is either “possibly in set” or “definitely not in set.” In some examples, probabilistic communication methods may improve user privacy by mitigating the ability to identify and/or track devices using secret-based probability-defined identification. Secret-based probabilistic methods may thus represent a privacy-preserving replacement for TIMs, and may be part of an enhanced data privacy (EDP) scheme (such as a task group bi (TGBi) EDP scheme). Further, some probabilistic mechanisms may not limit a total quantity of associated devices 304.

For example, given a subset S of clients C, a broadcaster B may form a broadcast which, when processed by any client C, results in an answer to a question of “Is C in S?” with potential results being “possibly yes” or “definitely no”, while providing no further info other than an approximate size of S. In some examples, a broadcaster B may form a broadcast message containing a bloom filter where, for each C in S, B may add a per-client element to the bloom filter that is derived from a key shared by B and C and a randomized, temporary, or device-unique variable, such as a nonce N associated with the broadcast. Each Client C, on receiving the broadcast, may query the bloom filter for the per-client element derived from the shared key and the nonce.

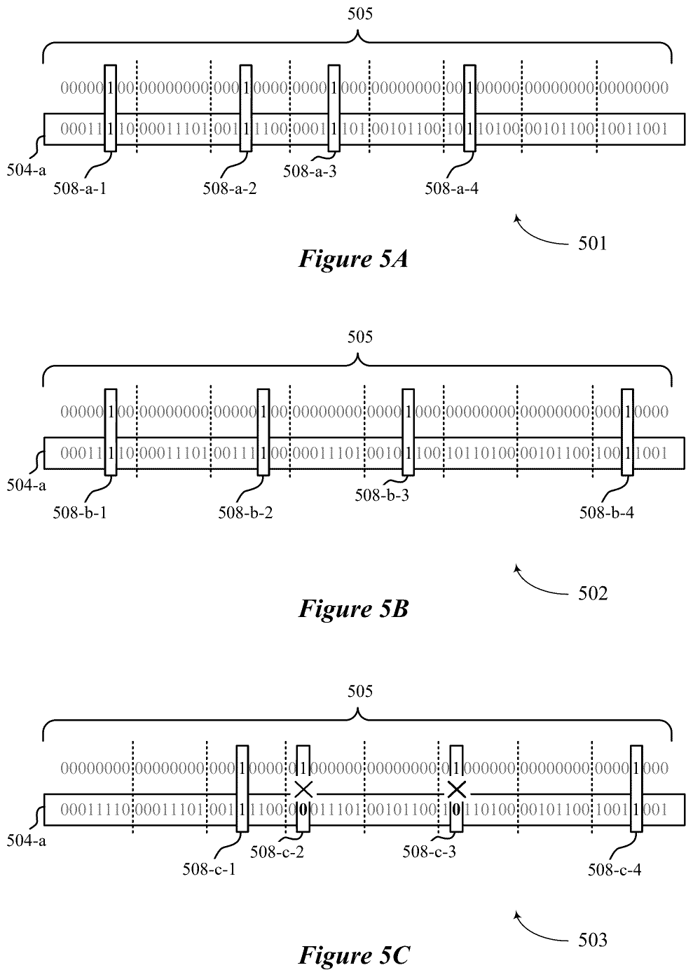

In the examples of FIG. 3, the device 304-a may establish one or more keys 312 with the devices 304-a, 304-b, and 304-c. For example, a key 312-a may be established with the device 302-a. The device 302-a may transmit a data object 314-a to the device 304-a via one or more channels of the downlink communication link 308, as well as to the devices 304-b and 304-c (such as via a broadcast message). The device 304-a may query a corresponding bloom filter to determine whether the device 304-a is within the set S. If the device 304-a determines it may potentially be in the set S, the device 304-a may remain in an active mode, or enter an active mode from a power saving mode (if data objects may be received while asleep), to monitor for data transmissions 316. The devices 304-b and 304-c also may monitor for transmissions 316 based on similar determinations. If the device 304-a is in the set S, the device 304-a may receive a data transmission 316-a. If the device 304-a determines a non-zero probability of being in the set, but is not in the set S (such as determines a false positive), the device 302-a may fail to detect a data transmission, and may return to a power saving mode (such as return to a sleep mode, or remain in a sleep mode if supporting data object reception while asleep). Alternatively, the device 304-a may determine that the device 304-a has a zero probability of being in the set S, and may refrain from monitoring for data transmissions. In some examples, adding an element to a bloom filter and querying a bloom filter for an element may be further discussed with respect to FIGS. 5A-5C.

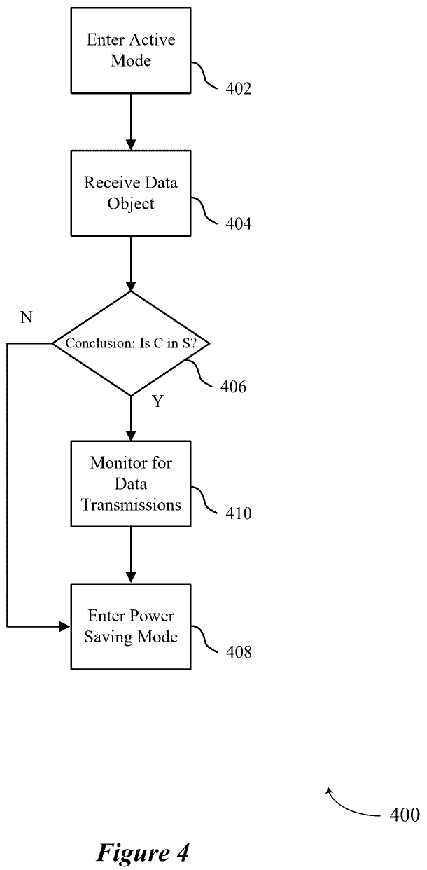

FIG. 4 shows an example of a flowchart 400 that supports tracking-resistant client indication using bloom filters. Aspects of the comparison flowchart 400 may implement, or be implemented by, aspects of the wireless communication network 100, the PDU 200, and the signaling diagram 300 as described herein with reference to FIGS. 1-3. For example, the flowchart 400 algorithm for determining whether a client C of a set of clients {C} (such as STAs 104) is in a set S of clients with pending traffic at a broadcaster B (such as an AP 102). In some examples, the flowchart 400 may illustrate an algorithm performed at the device 302-a based on receiving the data object 314-a.

At 402, a client C may enter an active mode, and may begin monitoring for reception of one or more transmissions. For example, the client C may exit a sleep mode to enter into the active mode to monitor for beacons transmitted by the broadcaster B. At 404, the broadcaster B may provide a data object D indicating a set S of clients C (such as set S of STAs 104 with traffic pending and buffered in an AP 102). Additionally, or alternatively, the client C may support reception of data objects while within a power saving mode, and may monitor for data objects without waking. In some examples, the set S may represent a set S[i], for example, for a given time interval i with one or more associated broadcast messages.

At 404, the client C may process data object D, and may perform one or more actions according to a conclusion of whether client C is in set S (such as STA 104 processes data object D to determine if STA 104 is in a set S of STAs 104). In some examples, at 406, the client C may determine a conclusion of whether the client C is in the set S based on processing a bloom filter.

For example, the client C may conclude that the client C (such as a STA A) is not in S. In such an example, the client C may proceed to 408 to enter, or re-enter, a power saving mode, such as a sleep mode. In such an example, the client C may not be in the set S, as there may be a zero probability of a client C that is not in S of concluding a “YES” result, or that the client C is within S (such as false negatives may not be present). In some examples, there may be a high probability less than 1 (such as less than 100%) that a client C which is not in the set S concludes a “NO” result, or concludes that the client C is not in the set S (such as makes a correct assumption based on the bloom filter or probabilistic algorithm). Additionally, or alternatively, the client C may not enter an active mode at 402, and so may remain in a power saving mode at 408 based on this determination (such as if supporting one or more communications of data objects in sleep mode).

Alternatively, the client C may conclude that the client C is in the set S, and may remain in an active mode and monitor for one or more data transmissions at 410. If the client C is indeed within the set S, the client C may receive one or more data transmissions and may afterward terminate monitoring and enter a power saving mode at 408. In some examples, there may be a probability of 1 (such as 100%) that the client C which is in the set S may make a correct conclusion of “YES”, or that the client Cis in the set S. Alternatively, if the client C is indeed not in the set S, but still determines a conclusion of “YES” (such as a false positive was generated), the client C may monitor for and may fail to receive any data transmissions at 410. After failing to receive one or more data transmissions, the client C may enter a power saving mode at 408. In some examples, there may be a relatively low probability greater than 0 (such as a non-zero probability) that a client C which is not in the set S concludes that the client Cis in the set according to a false positive. Additionally, or alternatively, if the client C does not enter an active mode at 402, the client C may first awaken at 410 before monitoring for transmissions (such as awakens to receive data transmissions or awakens unnecessarily based on a false positive). In some examples, determining a failure to receive a data transmission, and to enter a power saving mode, may be based on a timer, one or more counters, or another variable indicating that there is no traffic pending and buffered for the client C.

In some examples, the algorithm illustrated in FIG. 4 may enable tracking-resistance client indication (such as using a tracking resistant TIM mechanism) and privacy-preserving messaging. For example, implementing a secret-based probabilistic function, such as a bloom filter, may prevent other clients C from identifying or tracking the client C described herein. For example, {S[i]} may denote a series of sets S[i], with corresponding data objects D[i]. Even if a spying client C (such as STA 104) obtains S[j] corresponding to D[j], for all j≠i, the spying client C may determine no information about S[i] from D[i] (other than whether the spying client C is in S[i] or not, or an approximate size of S[i]). Additionally, or alternatively, utilizing a relatively small transmission size for a data object D may improve an efficiency of operations.

FIGS. 5A, 5B, and 5C show examples of comparison operations 501, 502, and 503 that support tracking-resistant client indication using bloom filters. Aspects of the comparison operations 501, 502, and 503 may implement, or be implemented by, aspects of the wireless communication network 100, the PDU 200, the signaling diagram 300, and the flowchart 400 as described herein with reference to FIGS. 1-4. For example, the comparison operations 501, 502, and 503 may illustrate different examples of operations done as part of processing a received bloom filter output for determining whether a client C (such as the device 302-a, a STA) is in a set S of clients with pending and buffered traffic.

In some examples, a bloom filter may represent a space-efficient probabilistic data structure that may be used to test whether an element is a member of a set. False positive matches may be possible, but false negatives may in some examples not be possible for bloom filters (such as a query returns either “possibly in set” or “definitely not in set”). Thus, a bloom filter may represent a data object, such as the data object 314-a, that may follow processes described in the flowchart 400. In some examples, an algorithm for a bloom filter may define an empty bloom filter as a bit array of m bits, where each bit location, or bit position, of the array of bits may be set to a value of ‘0’. There also may be k different hash functions defined, each of which may map or hash a set element to one of the m bit positions (such as bit array positions), which may generate a uniform random distribution. In some examples, k may be a relatively small constant which may depend on a desired false error rate ε, while m may be proportional to k and to a quantity of elements to be added, n (such as a quantity of clients C).

In some examples, to add an element (such as a client C or STA for which to generate a unique bit array), the element (or one or more parameters of the element) may be inserted into each of the k hash functions to obtain k bit positions, where each of the bits at these bit positions may be set to a value of ‘1.’ A corresponding bit array may be generated for each of a set of elements (such as for each C), where the values of the bit arrays may be combined using a logical OR function. To query for an element (such as test whether the element is in a set), the element may be inserted into each of the k hash functions to obtain a quantity k of bit positions corresponding to the element. If any of the bits in the bit array and at the bit positions corresponding to the element have a value of ‘0’, the element may not be in the set (such as “definitely not in set”). If each of the bit locations within the bit array and corresponding to the element have a value of ‘1’, either the element may be in the set, or the bits may have by chance been set to ‘1’ during insertion of other elements, resulting in a false positive.

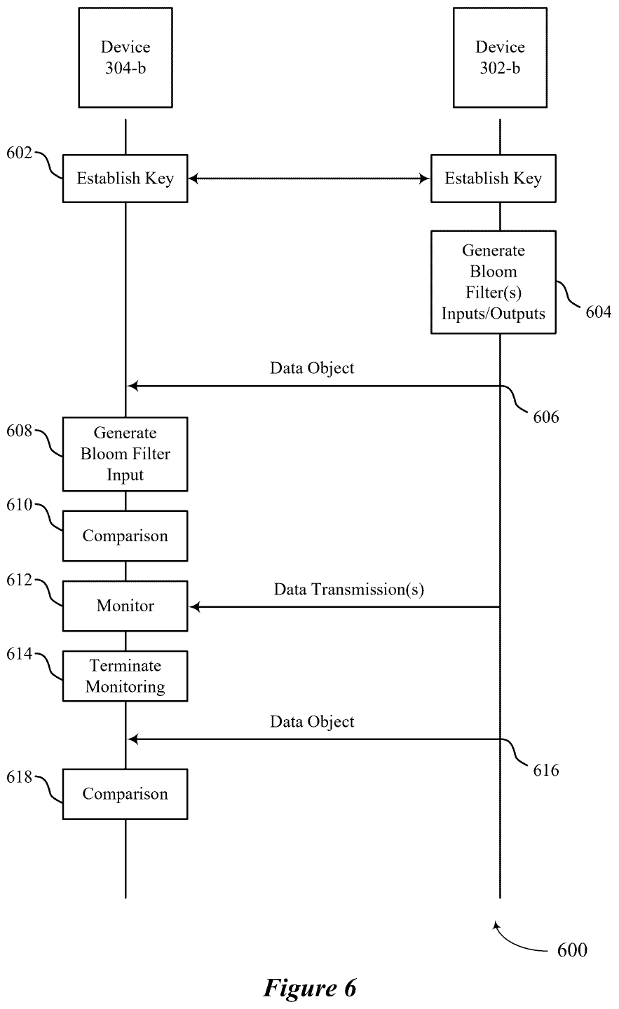

Bloom filters may be utilized to generate secret-based probabilistic traffic indications as described herein. For example, for each client C, the client C and a broadcaster B may (such as in a Step 1, or at 602 of FIG. 6) establish a unique secret key, K_{B,C}, which may be large enough to mitigate guessing or estimation using exhaustive testing (such as may be 128-bits).

For each target set S[i] (such as of one or more target sets of i broadcasts or time periods) the broadcaster B may generate a data object D[i] (such as the data object 314-a) using one or more steps (such as during a Step 2, or at 604 of FIG. 6). For example, (such as at a Step 2a) the broadcaster B may select one or more bloom filter parameters params[i] (such as Bloom Filter (BF) parameters) based on a size n [i] of the set S[i] and a probability p[i] of false positives. In some examples, the parameters may include the bloom filter size m[i] and a quantity of hash functions k [i], which may depend on a size of S[i] (such as depending on a quantity of clients with pending traffic instead of on a total quantity of clients).

In some examples, (such as at a Step 2b) the broadcaster B may determine a value, such as a number used once (nonce) N[i] or other unique or randomized value, which may be associated with the data object D[i]. In some examples, N[i] may be transmitted with D[i], or may be sent separately from D[i]. Additionally, or alternatively, nonce N[i] may be determined by or stored at (such as known at) the client C prior to receiving D[i]. For each Cin S[i], the broadcaster B (such as at a Step 2c) may derive one or more bloom filter input values in_{B,C}[i] from N[i] and K_{BC}, and (such as at a Step 2d) may form a bloom filter output, out[i], from the set of bloom filter inputs in_{B,C}[i]. In some examples, the contents of D[i] that is output (such as at a step 2e) may be represented as ((opt) params[i], out[i], (opt) N[i]), as N[i] and params[i] may be optionally included. For example, params[i] may be determined at the client C by calculating m[i] from receiving out[i], and k [i] may be a preset constant value or indicated in one or more configurations at the client C.

In some examples, (such as in a Step 3, or at 606, 608, and 610 of FIG. 6) each client C that receives data object D[i] may process D[i] by computing (such as in a Step 3a, or at 608 of FIG. 6) a respective in_{B,C}[i] (bloom filter input) from a randomized variable and a key, such as N[i] and K_{B,C}. In some examples, if N[i] is known to C prior to receiving D[i], then C can precompute in_{B,C}[i] prior to receiving D[i]. In some examples, the client C may process (such as in a Step 3b, or at 610 of FIG. 6) a received bloom filter output out[i] (such as per received or otherwise obtained params[i]) using in_{B,C}[i] to determine a conclusion of whether the client Cis in the set S[i] (such as determine if a query response results in a “YES” or “NO”). For example, C may determine a query response of “YES” based on each bit position of a set of bits that is set to ‘1’ being also set to ‘1’ in the bloom filter output out[i]. For a YES result, the C may perform actions (such as at 612 and 614 in FIG. 6) corresponding to being a member of S[i] as described herein (such as may enter an active mode). With this result, C is in S with probability (1−p[i]). Otherwise, for a “NO” result, the client C may perform actions corresponding to not being a member of S[i]. With this result, C may not be in S with a probability of 1 (such as Cis not in S, with a 100% probability).

In some examples, FIGS. 5A-5C may each illustrate bit arrays of example comparison operations for a set size n (such as 10 clients, 10 STAs), a bloom filter size 505 (such as 64 bits), and a relatively low false positive probability p[i] (such as ˜0.05). Further, although a bloom filter output 504 and potential bit positions 508 may be illustrated, any value combination may be used for parameters, inputs, and outputs of a bloom filter.

For example, during one or more initialization procedures, a broadcaster B and a client C(j) may establish a key K_{B,C(j)}, with 1≤j≤(a total quantity of clients connected with B). The broadcaster B may generate a bloom filter for a quantity of clients of a set S for which B has traffic pending (such as set S of 10 Clients C(j₁), C(j₂), . . . , C(j₁₀)). The broadcaster B may select bloom filter parameters params for the value n (such as n=10 values) and a false positive rate p (such as ˜0.05). In some examples, values m and k of params may be determined based on n and p (such as n=10, p=˜0.05 satisfied by m=64, and k=4), which may be independent of a total quantity of clients. In some examples, B may initialize an m bit value (such as 64 bits) for a bloom filter output 504-a (such as bloom filter out) to include a string of zero bits. For each j=jₐ, for 1≤a≤n, B may compute bloom filter input values in_{B,C(j)}. B may in some examples compute in_{B,C(j)} based on a using a pseudorandom function (PRF), for example, where in_{B,C(j)}=PRF (KR_{B,C(j)}, N, Length=log₂(m)×k) (such as N is a nonce and Length=6×4=24 bits=3 Bytes)). Thus, in may be an example of a randomized input to one or more hash functions for a bloom filter.

For each j=jₐ, and for 1≤a≤n, B may add bloom filter input values to the bloom filter using techniques described herein, for example, by using one or more hash functions H. In some examples, to add the bloom filter inputs, the broadcaster B may partition in_{B,C(j)} into k equal parts (such as 4 parts), which may each be input into a hash function Hⱼ. For example, for k=4 equal parts, Hⱼ(3)∥Hⱼ(2)∥Hⱼ(1)∥Hⱼ(0) may represent inputting four equal partitions, each with a size log₂(m)=6 bits, into a hash function, or into different hash functions. For example, Hⱼ(3) may represent a hash output from inputting a first partition into the hash function, where a hash output may be an example of a bit position 508. Doing so may generate a respective bit position 508 of a total k bit positions for a respective jth client Cⱼ.

By setting out[Hⱼ(3)]=‘1’, out[Hⱼ(2)]=‘1’, out[Hⱼ(1)]=‘1’, out[Hⱼ(0)]=‘1’ (such as setting corresponding hash output bit positions of out to ‘1’), the broadcaster B may generate a bit array for the bloom filter output 504-a, including bit positions 508 set to a value of ‘1’ for each client Cⱼ of the S clients with traffic. In some examples, this process may set up to k (such as k=4) bits of the bloom filter output 504-a (such as out) to the value of ‘1’ for each client C in S, in some examples, up to a maximum quantity of bits (such as 40 bits). In some examples, if a bit of the bloom filter output 504-a is already set to a value of ‘1’ when adding bit positions for a new client C, the bit position may be set to ‘1’ again, or in similarly, may remain a value of ‘1’ (such as a “collision” between bits may happen, decreasing a total quantity of bit positions 508 that are set to ‘1’ than a sum of total bit positions calculated). This may effectively perform a logic OR operation on respective bit positions 508 of each of the n clients C. In some examples, by utilizing unique keys K and nonces N for each of the clients C, the bits generated may be unique, secret, and may change as nonce values change. For example, a nonce changing over time may result in bit positions based on a same key changing over time rather than being the same, and so in addition to using secret bit positions, other brute force determination methods may be mitigated as the secret values also may change over time.

After generating the bloom filter output 504-a, the broadcaster B may broadcast a data object including the bloom filter output 504-a (and/or one or more of params and nonces N). A client C(j) may process the bloom filter output 504-a by generating the bit positions 508 corresponding to that client. For example, C(j) may compute a quantity of hash bits that may be equal to log₂(m)×k (such as 6×4=24 bits). C(j) may further compute a bloom filter input in_{B,C(j)} using a PRF with PRF (K_{B,C(j)}, C(j), N) to output a quantity of hash bits, and may partition in_{B,C(j)} into k equal parts (such as Hⱼ(3)∥Hⱼ(2)∥Hⱼ(1)∥Hⱼ(0)) to generate one or more bit positions 508. C(j) may determine if out[Hⱼ(3)]=out[Hⱼ(2)]=out[Hⱼ(1)]=out[Hⱼ(0)]=‘1’. For example, such a determination may be represented by comparing generated bit positions 508 to the bit array of the bloom filter output 504-a, and checking bit positions tested by a client C(j) (such as A(j)), such as a client C(j₄) (such as A(j₄)).

In the example of FIG. 5A, a first client C(j) may detect a true positive result or conclusion. For example, the first client C(j) may generate the bit positions 508-a-1, 508-a-2, 508-a-3, and 508-a-4, and may determine that each of the bit positions 508-a may be set to ‘1’ in the received bloom filter output 504-a. In some examples, the bit positions 508-a may be set to ‘1’ by the broadcaster B based on the client being within the set S, and so may represent a true positive result. Additionally, or alternatively, in the FIG. 5B, a second client C(j) may detect a false positive. For example, the second client C(j) may not be part of the set S, even though each of bit positions 508-b-1, 508-b-2, 508-b-3, and 508-b-4 generated by and corresponding to the second client may be set to ‘1’. For example, such bits may represent overlap bit positions randomly generated to indicate traffic for one or more other clients that are in the set S. In some examples, if the bits match, or are set to ‘1’, an output “YES” may be determined, and may thus indicate that C(j) is in S with a non-certain probability (such as 95%).

In the example of FIG. 5C, a third client C(j) may detect a true negative result. For example, the third client C(j) may generate and check bit positions 508-c-1, 508-c-2, 508-c-3, and 508-c-4, and may determine that the bit positions 508-c-2 and 508-c-3 are set to ‘0’ in the bloom filter output 504-a. If this check is false, an output may be “NO”, where the third client C(j) may not be in S according to a certain probability (such as 100%). In some examples, other methods may be used to generate a hash output. For example, multiple hash functions H may be used (such as a separate hash function for each partition), or a single randomized value may be input into four separate hash functions H to determine k bit positions 508. Additionally, or alternatively, different types of hash functions, randomization calculations, and/or parameters may be used to generate bit positions 508.

In some examples, the parameters or values n, p, m, and k may be calculated according to Equation 1, Equation 2, Equation 3, and Equation 4 below:

$$n = ceil ( m / ( - k / log ( 1 - exp ( log ( p ) / k ) ) ) ) \qquad ( 1 )$$

$$p = pow ( 1 - exp ( - k / ( m / n ) ) , k ) \qquad ( 2 )$$

$$m = ceil ( ( n * log ( p ) ) / log ( 1 / pow ( 2 , log ( 2 ) ) ) ) ; \qquad ( 3 )$$

$$k = round ( ( m / n ) * log ( 2 ) ) ; \qquad ( 4 )$$

In some examples, a size of a bloom filter output 504 may be based on n and p according to Equation 3. Further, increasing a probability value p may increase a likelihood of false positives, which may result in increased privacy, but may increase power usage at a device as it wakes up more frequently. In some examples, a false likelihood probability p may be reduced by increasing a size m of a bloom filter.

In some examples, a nonce N (such as one-time client value) or other value used in place of a nonce may be unique to a single broadcast (S[i]), or may be used for multiple broadcasts (S[i], . . . , S[i+T]) within a defined time interval. Further, such a value may include an incrementing counter or a decrementing counter, a time value (such as timing synchronization function (TSF), target beacon transmission time (TBTT) associated with a broadcast or set of broadcasts, such as a TBTT of a beacon frame or TIM frame), or may include a value restricting scope (such as an identifier for a broadcaster, such as a basic service set identifier (BSSID) of an AP, or a set of broadcasters, such as a service set identifier (SSID) of an extended service set (ESS)). A time associated with how often this value changes may in some examples determine a maximum quantity of time that tracking may be possible (such as and so more frequently changed values may increase security).

In some examples, a per-client key K_{B,C} (such as authentication key) may be a secret key known to a corresponding client C and one or more trusted broadcasters B. In some examples, the key may be known to a single broadcaster B (such as single AP). In some other examples, a key may be shared between multiple broadcasters B (such as multiple APs in an ESS). Additionally, or alternatively, a key may be a long-term key, a short-term key, may be derived from another key, or may be derived using a handshake procedure. In some examples, a key K_{B,C} may be determined at a time that a STA associates with an AP (such as may be derived from a key derivation key (KDK)). In some examples, a broadcaster B may generate a temporary secret client value (such as bit positions 508) from a unique nonce N associated with a broadcast and a secret key K.

In some examples, a broadcaster B may implement one or more methods to further hide one or more parameters or information about one or more clients C. For example, to hide a size S of a set including traffic (such as when selecting bloom filter parameters params) a broadcaster B may select output parameters based on a false size (such as fake size, inaccurate size) n_{f} that may be greater than a real size n of S. Further, when forming a bloom filter output 504-a, the broadcaster B may randomly set more bits (such as of out) to a value ‘1’ to mimic bit positions corresponding to a set of a false size. Further, a total quantity of bits, or size of the bloom filter m, may be increased to hide the size of S (as m may in some examples be based on n). Other false values and methods may further be performed to hide details of one or more clients.

Using the techniques described herein, a broadcaster B may produce a broadcast value anonymously identifying a selected set of clients (such as by including a bloom filter in a broadcast value) including, for example, a temporary secret client value (such as one or more bit positions 508) as described herein. The methods described herein may improve security, or example, by preventing tracking to obfuscate device identification, as a client (such as STA) may learn information about itself but may learn nothing on other specific clients as it may be unaware of bit positions to check (such as due to the secret client value being based on a secret key). Further, the described methods may be probabilistic, which may improve efficiency compared to deterministic methods, and may have a relatively low impact on power usage and transmissions. In some examples, using bloom filter outputs may increase efficiency in transmissions, as a size of a broadcast may depend on a quantity of clients with pending traffic instead of on a total quantity of associated clients. Further, such a broadcast data object may be scalable so that a total quantity of associated clients may be theoretically unlimited (such as instead of limited to TIM or AID size).

FIG. 6 shows an example of a process flow 600 that supports tracking-resistant client indication using bloom filters. Aspects of the process flow 600 may implement, or be implemented by, aspects of the wireless communication network 100, the PDU 200, the signaling diagram 300, the flowchart 400, and comparison operations 501, 502, and 503 as described herein with reference to FIGS. 1-4 and 5A-5C. For example, the process flow 600 may include a device 302-b (such as a broadcaster B, an AP 102) in communication with one or more devices 304, such as a device 304-b (such as a client C, a STA 104). In some examples, the process flow 600 may illustrate utilizing bloom filters for traffic indications as described herein.

In the following description of the process flow 600, the operations may be performed (such as reported or provided) in a different order than the order shown, or the operations performed by the example devices may be performed in different orders or at different times. Some operations also may be omitted from the process flow 600, or other operations may be added to the process flow 600. Further, although some operations or signaling may be shown to occur at different times for discussion purposes, these operations may actually occur at the same time or at least partially concurrently.

At 602, the device 302-b may establish a set of multiple authentication keys (such as keys K) with a set of multiple devices 304. For example, the device 304-b and the device 302-b may establish an authentication key with each other.

At 604, the device 302-b may generate one or more respective bloom filter inputs associated with the one or more devices 304, such as the device 304-b, based on one or more respective authentication keys of the set of multiple authentication keys and one or more respective randomization values. In some examples, the 302-b may generate a bloom filter output (such as a bloom filter output 504, out) that may be based on the one or more respective bloom filter inputs (such as in), a bloom filter size (such as m), and a quantity of hash functions (such as k). In some examples, the bloom filter output may include one or more bit positions (such as bit positions 508) that are set to a value of 1 and that are different than one or more additional bit positions that are set to the value of 1 based on the one or more respective bloom filter inputs, the quantity of hash functions, and one or more randomized bit values (such as one or more nonces N).

In some examples, the device 302-b may select one or more bloom filter parameters (such as p and n) where a bloom filter size for the bloom filter inputs and output, and the quantity of hash functions, may be based on the one or more bloom filter parameters. In some examples, the bloom filter size may be greater than a second bloom filter size associated with the one or more devices 304 (such as may be a fake size).

At 606, the device 302-b may transmit a data object (such as D) via one or more channels indicating the bloom filter output, which may be received by one or more devices 304-b, including the device 304-b. In some examples, the bloom filter output may indicate that one or more devices 304 of a set of multiple devices 304 is to monitor for data transmission. Additionally, or alternatively, the 302-b may transmit, and one or more devices 304 such as the device 304-b may receive, respective randomization values (such as nonces N) via the data object, via one or more separate messages, or both. Additionally, or alternatively, the data object may indicate a bloom filter size, a quantity of hash functions, or both. In some examples, the data object may be a broadcast data object identifying which of the set of multiple devices 304 is to monitor for data transmission.

At 608, the device 304-b may generate a bloom filter input (such as a unique input in) associated with the device 304-b based on the authentication key established at 602 and a randomization value (such as indicated in the data object or another message received at the device 304-b, or determined at the device 304-b).

At 612, the device 304 may monitor for data transmissions based on the bloom filter output. For example, the device 304-b may monitor for a data transmission based on a comparison at 610 between a set of bit positions and the bloom filter output, the set of bit positions being based on the authentication key, and the comparison indicating that the first wireless communication device is to monitor for the data transmission. In some examples, the set of bit positions associated with the device 304-b may be based on the bloom filter input, a bloom filter size, and a quantity of hash functions. Additionally, or alternatively, the comparison may indicate that the first wireless communication device is to monitor for the data transmission by indicating that the device 304-b has a non-zero probability of being associated with one or more pending data transmissions. In some examples, at 612, the device 302-b may transmit one or more data transmissions associated with the devices 304 based on the data object. For example, the device 304-b may receive a data transmission from the device 302-b based on the monitoring.

At 614, the device 304-b may terminate the monitoring based on receiving the data transmission. Additionally, or alternatively, if the device 304-b fails to receive a data transmission, the device 304-b may terminate the monitoring based on failure to receive the data transmission. The device 304-b may enter a power saving mode (such as a sleep mode) based on the terminating.

At 616, the device 304-b may receive a second data object including a second bloom filter output, and at 618, may determine not to monitor for a second data transmission based on a second comparison between a second set of bit positions and the second bloom filter output. For example, the second set of bit positions may be based on the authentication key and the second comparison may indicate that the device 304-b has a zero probability of being associated with one or more second data transmissions.

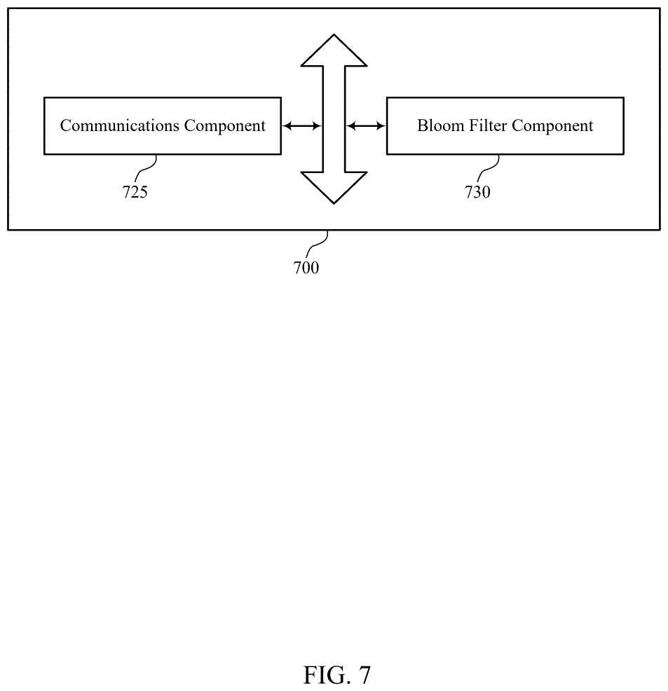

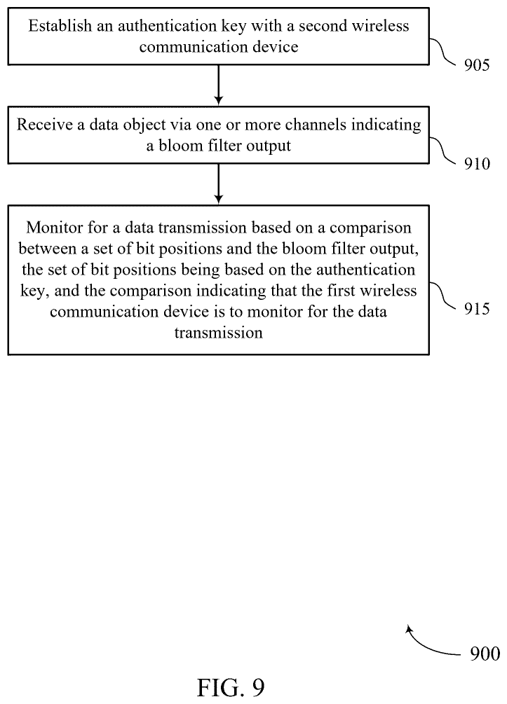

FIG. 7 shows a block diagram of an example wireless communication device 700 that supports tracking-resistant client indication using bloom filters. In some examples, the wireless communication device 700 is configured to perform the process 900 described with reference to FIG. 9. The wireless communication device 700 may include one or more chips, SoCs, chipsets, packages, components or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is passed to the processing system. In some such examples, the first interface also may obtain information, such as from the transmission component, and the second interface also may output information, such as to the reception component.

The processing system of the wireless communication device 700 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 700 can be configurable or configured for use in a STA, such as the STA 104 described with reference to FIG. 1. In some other examples, the wireless communication device 700 can be a STA that includes such a processing system and other components including multiple antennas. The wireless communication device 700 is capable of transmitting and receiving wireless communications in the form of, for example, wireless packets. For example, the wireless communication device 700 can be configurable or configured to transmit and receive packets in the form of physical layer PPDUs and MPDUs conforming to one or more of the IEEE 802.11 family of wireless communication protocol standards. In some other examples, the wireless communication device 700 can be configurable or configured to transmit and receive signals and communications conforming to one or more 3GPP specifications including those for 5G NR or 6G. In some examples, the wireless communication device 700 also includes or can be coupled with one or more application processors which may be further coupled with one or more other memories. In some examples, the wireless communication device 700 further includes a user interface (UI) (such as a touchscreen or keypad) and a display, which may be integrated with the UI to form a touchscreen display that is coupled with the processing system. In some examples, the wireless communication device 700 may further include one or more sensors such as, for example, one or more inertial sensors, accelerometers, temperature sensors, pressure sensors, or altitude sensors, that are coupled with the processing system.

The wireless communication device 700 includes a communications component 725 and a bloom filter component 730. Portions of one or more of the communications component 725 and the bloom filter component 730 may be implemented at least in part in hardware or firmware. For example, one or more of the communications component 725 and the bloom filter component 730 may be implemented at least in part by at least a processor or a modem. In some examples, portions of one or more of the communications component 725 and the bloom filter component 730 may be implemented at least in part by a processor and software in the form of processor-executable code stored in memory.

The wireless communication device 700 may support wireless communications in accordance with examples as disclosed herein. The communications component 725 is configurable or configured to establish an authentication key with a second wireless communication device. The bloom filter component 730 is configurable or configured to receive a data object via one or more channels indicating a bloom filter output. In some examples, the communications component 725 is configurable or configured to monitor for a data transmission based on a comparison between a set of bit positions and the bloom filter output, the set of bit positions being based on the authentication key, and the comparison indicating that the first wireless communication device is to monitor for the data transmission.

In some examples, the bloom filter component 730 is configurable or configured to generate a bloom filter input associated with the first wireless communication device based on the authentication key and a randomization value, where the set of bit positions is based on the bloom filter input, a bloom filter size, and a quantity of hash functions.

In some examples, the bloom filter component 730 is configurable or configured to receive the randomization value via the data object, via a separate message, or both.

In some examples, the communications component 725 is configurable or configured to receive a data transmission based on the monitoring.

In some examples, the communications component 725 is configurable or configured to terminate the monitoring based on failure to receive the data transmission. In some examples, the communications component 725 is configurable or configured to enter a power saving mode based on the terminating.

In some examples, the data object indicates a bloom filter size, a quantity of hash functions, or both, where the set of bit positions may be based on the bloom filter size, the quantity of hash functions, or both.

In some examples, the comparison indicates that the first wireless communication device is to monitor for the data transmission by indicating that the first wireless communication device has a non-zero probability of being associated with one or more pending data transmissions.

In some examples, the bloom filter component 730 is configurable or configured to receive a second data object including a second bloom filter output. In some examples, the communications component 725 is configurable or configured to determine not to monitor for a second data transmission based on a second comparison between a second set of bit positions and the second bloom filter output, the second set of bit positions being based on the authentication key, and the second comparison indicating that the first wireless communication device has a zero probability of being associated with the second data transmission.

In some examples, the data object may be a broadcast data object identifying which of a set of multiple first wireless communication devices, including the first wireless communication device, is to monitor for data transmission. In some examples, the first wireless communication device includes a STA and the second wireless communication device includes an AP.

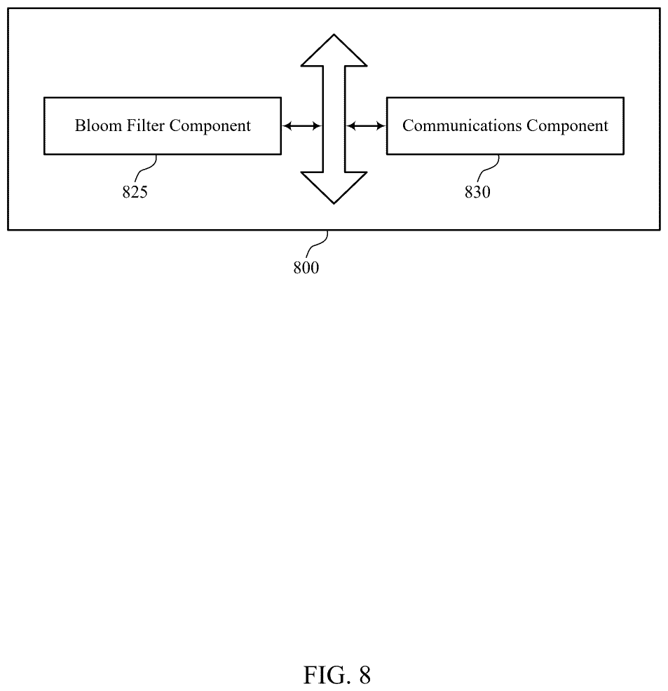

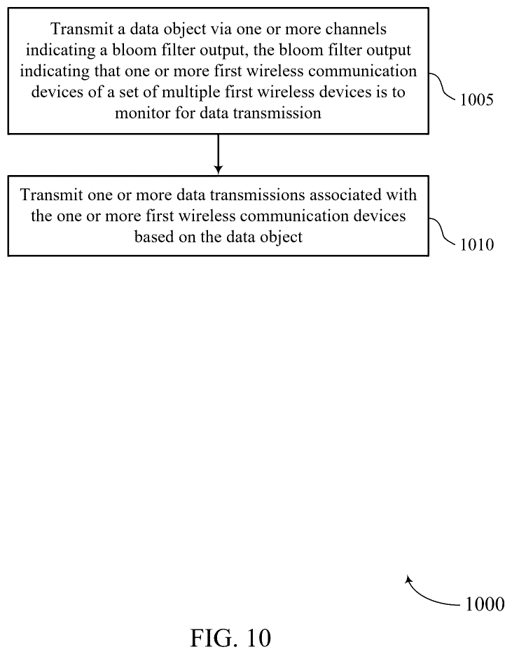

FIG. 8 shows a block diagram of an example wireless communication device 800 that supports tracking-resistant client indication using bloom filters. In some examples, the wireless communication device 800 is configured to perform the process 1000 described with reference to FIG. 10. The wireless communication device 800 may include one or more chips, SoCs, chipsets, packages, components or devices that individually or collectively constitute or include a processing system. The processing system may interface with other components of the wireless communication device 800, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 800 may transmit the information output from the chip. In such an example, the second interface may refer to an interface between the processing system of the chip and a reception component, such that the wireless communication device 800 may receive information that is passed to the processing system. In some such examples, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 800 can be configurable or configured for use in an AP, such as the AP 102 described with reference to FIG. 1. In some other examples, the wireless communication device 800 can be an AP that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of physical layer PPDUs and MPDUs conforming to one or more of the IEEE 802.11 family of wireless communication protocol standards. In some other examples, the wireless communication device 800 can be configurable or configured to transmit and receive signals and communications conforming to one or more 3GPP specifications including those for 5G NR or 6G. In some examples, the wireless communication device 800 also includes or can be coupled with one or more application processors which may be further coupled with one or more other memories. In some examples, the wireless communication device 800 further includes at least one external network interface coupled with the processing system that enables communication with a core network or backhaul network that enables the wireless communication device 800 to gain access to external networks including the Internet.

The wireless communication device 800 includes a bloom filter component 825 and a communications component 830. Portions of one or more of the bloom filter component 825 and the communications component 830 may be implemented at least in part in hardware or firmware. For example, one or more of the bloom filter component 825 and the communications component 830 may be implemented at least in part by at least a processor or a modem. In some examples, portions of one or more of the bloom filter component 825 and the communications component 830 may be implemented at least in part by a processor and software in the form of processor-executable code stored in memory.

The wireless communication device 800 may support wireless communications in accordance with examples as disclosed herein. The bloom filter component 825 is configurable or configured to transmit a data object via one or more channels indicating a bloom filter output, the bloom filter output indicating that one or more first wireless communication devices of a set of multiple first wireless communication devices is to monitor for data transmission. The communications component 830 is configurable or configured to transmit one or more data transmissions associated with the one or more first wireless communication devices based on the data object.

In some examples, the communications component 830 is configurable or configured to establish a set of multiple authentication keys with the set of multiple first wireless communication devices. In some examples, the bloom filter component 825 is configurable or configured to generate one or more respective bloom filter inputs associated with the one or more first wireless communication devices based on one or more respective authentication keys of the set of multiple authentication keys and one or more respective randomization values, where the bloom filter output is based on the one or more respective bloom filter inputs, a bloom filter size, and a quantity of hash functions.

In some examples, the bloom filter component 825 is configurable or configured to transmit the one or more respective randomization values via the data object, via one or more separate messages, or both.

In some examples, the bloom filter output includes one or more bit positions that are set to a value of 1 and that are different than one or more additional bit positions that are set to the value of 1 based on the one or more respective bloom filter inputs, the quantity of hash functions, and one or more randomized bit values.

In some examples, the bloom filter component 825 is configurable or configured to select one or more bloom filter parameters, where a bloom filter size and a quantity of hash functions are based on the one or more bloom filter parameters.

In some examples, the bloom filter size is greater than a second bloom filter size associated with the one or more first wireless communication devices.

In some examples, the data object indicates a bloom filter size, a quantity of hash functions, or both.

In some examples, the data object may be a broadcast data object identifying which of the set of multiple first wireless communication devices is to monitor for data transmission. In some examples, the one or more first wireless communication devices include one or more stations (STA) and the second wireless communication device includes an AP.

FIG. 9 shows a flowchart illustrating an example process 900 performable by or at a first wireless communication device that supports tracking-resistant client indication using bloom filters. The operations of the process 900 may be implemented by a first wireless communication device or its components as described herein. For example, the process 900 may be performed by a wireless communication device, such as the wireless communication device 700 described with reference to FIG. 7, operating as or within a wireless STA. In some examples, the process 900 may be performed by a wireless STA, such as one of the STAs 104 described with reference to FIG. 1.

In some examples, in 905, the first wireless communication device may establish an authentication key with a second wireless communication device. The operations of 905 may be performed in accordance with examples as disclosed herein. In some implementations, aspects of the operations of 905 may be performed by a communications component 725 as described with reference to FIG. 7.

In some examples, in 910, the first wireless communication device may receive a data object via one or more channels indicating a bloom filter output. The operations of 910 may be performed in accordance with examples as disclosed herein. In some implementations, aspects of the operations of 910 may be performed by a bloom filter component 730 as described with reference to FIG. 7.

In some examples, in 915, the first wireless communication device may monitor for a data transmission based on a comparison between a set of bit positions and the bloom filter output, the set of bit positions being based on the authentication key, and the comparison indicating that the first wireless communication device is to monitor for the data transmission. The operations of 915 may be performed in accordance with examples as disclosed herein. In some implementations, aspects of the operations of 915 may be performed by a communications component 725 as described with reference to FIG. 7.

FIG. 10 shows a flowchart illustrating an example process 1000 performable by or at a second wireless communication device that supports tracking-resistant client indication using bloom filters. The operations of the process 1000 may be implemented by a second wireless communication device or its components as described herein. For example, the process 1000 may be performed by a wireless communication device, such as the wireless communication device 800 described with reference to FIG. 8, operating as or within a wireless AP. In some examples, the process 1000 may be performed by a wireless AP, such as one of the APs 102 described with reference to FIG. 1.

In some examples, in 1005, the second wireless communication device may transmit a data object via one or more channels indicating a bloom filter output, the bloom filter output indicating that one or more first wireless communication devices of a set of multiple first wireless communication devices is to monitor for data transmission. The operations of 1005 may be performed in accordance with examples as disclosed herein. In some implementations, aspects of the operations of 1005 may be performed by a bloom filter component 825 as described with reference to FIG. 8.

In some examples, in 1010, the second wireless communication device may transmit one or more data transmissions associated with the one or more first wireless communication devices based on the data object. The operations of 1010 may be performed in accordance with examples as disclosed herein. In some implementations, aspects of the operations of 1010 may be performed by a communications component 830 as described with reference to FIG. 8.

Implementation examples are described in the following numbered clauses:

The following provides an overview of aspects of the present disclosure:

Aspect 1: A method for wireless communications by a first wireless communication device, including: establishing an authentication key with a second wireless communication device; receiving a data object via one or more channels indicating a bloom filter output; and monitoring for a data transmission based at least in part on a comparison between a set of bit positions and the bloom filter output, the set of bit positions being based at least in part on the authentication key, and the comparison indicating that the first wireless communication device is to monitor for the data transmission.

Aspect 2: The method of aspect 1, further including: generating a bloom filter input associated with the first wireless communication device based at least in part on the authentication key and a randomization value, where the set of bit positions is based at least in part on the bloom filter input, a bloom filter size, and a quantity of hash functions.

Aspect 3: The method of aspect 2, further including: receiving the randomization value via the data object, via a separate message, or both.

Aspect 4: The method of any of aspects 1-3, further including: receiving a data transmission based at least in part on the monitoring.

Aspect 5: The method of any of aspects 1-4, further including: terminating the monitoring based at least in part on failure to receive the data transmission; and entering a power saving mode based at least in part on the terminating.

Aspect 6: The method of any of aspects 1-5, where the data object indicates a bloom filter size, a quantity of hash functions, or both, where the set of bit positions is based at least in part on the bloom filter size, the quantity of hash functions, or both.

Aspect 7: The method of any of aspects 1-6, where the comparison indicates that the first wireless communication device is to monitor for the data transmission by indicating that the first wireless communication device has a non-zero probability of being associated with one or more pending data transmissions.

Aspect 8: The method of any of aspects 1-7, further including: receiving a second data object including a second bloom filter output; and determining not to monitor for a second data transmission based at least in part on a second comparison between a second set of bit positions and the second bloom filter output, the second set of bit positions being based at least in part on the authentication key, and the second comparison indicating that the first wireless communication device has a zero probability of being associated with the second data transmission.

Aspect 9: The method of any of aspects 1-8, where the data object is a broadcast data object identifying which of a plurality of first wireless communication devices, including the first wireless communication device, is to monitor for data transmission.

Aspect 10: The method of any of aspects 1-9, where the first wireless communication device includes a STA and the second wireless communication device includes an AP.

Aspect 11: A method for wireless communications by a second wireless communication device, including: transmitting a data object via one or more channels indicating a bloom filter output, the bloom filter output indicating that one or more first wireless communication devices of a plurality of first wireless communication devices is to monitor for data transmission; and transmitting one or more data transmissions associated with the one or more first wireless communication devices based at least in part on the data object.

Aspect 12: The method of aspect 11, further including: establishing a plurality of authentication keys with the plurality of first wireless communication devices; and generating one or more respective bloom filter inputs associated with the one or more first wireless communication devices based at least in part on one or more respective authentication keys of the plurality of authentication keys and one or more respective randomization values, where the bloom filter output is based at least in part on the one or more respective bloom filter inputs, a bloom filter size, and a quantity of hash functions.

Aspect 13: The method of aspect 12, further including: transmitting the one or more respective randomization values via the data object, via one or more separate messages, or both.

Aspect 14: The method of any of aspects 12-13, where the bloom filter output includes one or more bit positions that are set to a value of 1 and that are different than one or more additional bit positions that are set to the value of 1 based at least in part on the one or more respective bloom filter inputs, the quantity of hash functions, and one or more randomized bit values.

Aspect 15: The method of any of aspects 11-14, further including: selecting one or more bloom filter parameters, where a bloom filter size and a quantity of hash functions are based at least in part on the one or more bloom filter parameters.

Aspect 16: The method of aspect 15, where the bloom filter size is greater than a second bloom filter size associated with the one or more first wireless communication devices.

Aspect 17: The method of any of aspects 11-16, where the data object indicates a bloom filter size, a quantity of hash functions, or both.

Aspect 18: The method of any of aspects 11-17, where the data object is a broadcast data object identifying which of the plurality of first wireless communication devices is to monitor for data transmission.

Aspect 19: The method of any of aspects 11-18, where the one or more first wireless communication devices include one or more STAs and the second wireless communication device includes an AP.

Aspect 20: A first wireless communication device for wireless communications, including one or more memories storing processor-executable code, and one or more processors coupled with the one or more memories and individually or collectively operable to execute the code to cause the first wireless communication device to perform a method of any of aspects 1-10.

Aspect 21: A first wireless communication device for wireless communications, including at least one means for performing a method of any of aspects 1-10.

Aspect 22: A non-transitory computer-readable medium storing code for wireless communications, the code including instructions executable by one or more processors to perform a method of any of aspects 1-10.

Aspect 23: A second wireless communication device for wireless communications, including one or more memories storing processor-executable code, and one or more processors coupled with the one or more memories and individually or collectively operable to execute the code to cause the second wireless communication device to perform a method of any of aspects 11-19.

Aspect 24: A second wireless communication device for wireless communications, including at least one means for performing a method of any of aspects 11-19.

Aspect 25: A non-transitory computer-readable medium storing code for wireless communications, the code including instructions executable by one or more processors to perform a method of any of aspects 11-19.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a’,” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some examples be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless communication device, comprising:
a processing system that includes processor circuitry and memory circuitry that stores code, the processing system configured to cause the first wireless communication device to:
establish an authentication key with a second wireless communication device;
receive a data object via one or more channels indicating a bloom filter output; and
monitor for a data transmission based at least in part on a comparison between a set of bit positions and the bloom filter output, the set of bit positions being based at least in part on the authentication key, and the comparison indicating that the first wireless communication device is to monitor for the data transmission.

2. The first wireless communication device of claim 1, wherein the processing system is further configured to cause the first wireless communication device to:
generate a bloom filter input associated with the first wireless communication device based at least in part on the authentication key and a randomization value,
wherein the set of bit positions is based at least in part on the bloom filter input, a bloom filter size, and a quantity of hash functions.

3. The first wireless communication device of claim 2, wherein the processing system is further configured to cause the first wireless communication device to:
receive the randomization value via the data object, via a separate message, or both.

4. The first wireless communication device of claim 1, wherein the processing system is further configured to cause the first wireless communication device to:
receive a data transmission based at least in part on the monitoring.

5. The first wireless communication device of claim 1, wherein the processing system is further configured to cause the first wireless communication device to:
terminate the monitoring based at least in part on failure to receive the data transmission; and
enter a power saving mode based at least in part on the terminating.

6. The first wireless communication device of claim 1,
wherein the data object indicates a bloom filter size, a quantity of hash functions, or both, and
wherein the set of bit positions is based at least in part on the bloom filter size, the quantity of hash functions, or both.

7. The first wireless communication device of claim 1,
wherein the comparison indicates that the first wireless communication device is to monitor for the data transmission by indicating that the first wireless communication device has a non-zero probability of being associated with one or more pending data transmissions.

8. The first wireless communication device of claim 1, wherein the processing system is further configured to cause the first wireless communication device to:
receive a second data object comprising a second bloom filter output; and
determine not to monitor for a second data transmission based at least in part on a second comparison between a second set of bit positions and the second bloom filter output, the second set of bit positions being based at least in part on the authentication key, and the second comparison indicating that the first wireless communication device has a zero probability of being associated with the second data transmission.

9. The first wireless communication device of claim 1, wherein the data object is a broadcast data object identifying which of a plurality of first wireless communication devices, comprising the first wireless communication device, is to monitor for data transmission.

10. The first wireless communication device of claim 1, wherein the first wireless communication device comprises a station (STA) and the second wireless communication device comprises an access point (AP).

11. A second wireless communication device, comprising:
a processing system that includes processor circuitry and memory circuitry that stores code, the processing system configured to cause the second wireless communication device to:
transmit a data object via one or more channels indicating a bloom filter output, the bloom filter output indicating that one or more first wireless communication devices of a plurality of first wireless communication devices is to monitor for data transmission; and
transmit one or more data transmissions associated with the one or more first wireless communication devices based at least in part on the data object.

12. The second wireless communication device of claim 11, wherein the processing system is further configured to cause the second wireless communication device to:
establish a plurality of authentication keys with the plurality of first wireless communication devices; and
generate one or more respective bloom filter inputs associated with the one or more first wireless communication devices based at least in part on one or more respective authentication keys of the plurality of authentication keys and one or more respective randomization values, wherein the bloom filter output is based at least in part on the one or more respective bloom filter inputs, a bloom filter size, and a quantity of hash functions.

13. The second wireless communication device of claim 12, wherein the processing system is further configured to cause the second wireless communication device to:
transmit the one or more respective randomization values via the data object, via one or more separate messages, or both.

14. The second wireless communication device of claim 12,
wherein the bloom filter output comprises one or more bit positions that are set to a value of 1 and that are different than one or more additional bit positions that are set to the value of 1 based at least in part on the one or more respective bloom filter inputs, the quantity of hash functions, and one or more randomized bit values.

15. The second wireless communication device of claim 11, wherein the processing system is further configured to cause the second wireless communication device to:
select one or more bloom filter parameters,
wherein a bloom filter size and a quantity of hash functions are based at least in part on the one or more bloom filter parameters.

16. The second wireless communication device of claim 15,
wherein the bloom filter size is greater than a second bloom filter size associated with the one or more first wireless communication devices.

17. The second wireless communication device of claim 11,
wherein the data object indicates a bloom filter size, a quantity of hash functions, or both.

18. The second wireless communication device of claim 11, wherein the data object is a broadcast data object identifying which of the plurality of first wireless communication devices is to monitor for data transmission.

19. The second wireless communication device of claim 11,
wherein the one or more first wireless communication devices comprise one or more stations (STA) and the second wireless communication device comprises an access point (AP).

20. A method for wireless communications by a first wireless communication device, comprising:
establishing an authentication key with a second wireless communication device;
receiving a data object via one or more channels indicating a bloom filter output; and
monitoring for a data transmission based at least in part on a comparison between a set of bit positions and the bloom filter output, the set of bit positions being based at least in part on the authentication key, and the comparison indicating that the first wireless communication device is to monitor for the data transmission.

21. The method of claim 20, further comprising:
generating a bloom filter input associated with the first wireless communication device based at least in part on the authentication key and a randomization value,
wherein the set of bit positions is based at least in part on the bloom filter input, a bloom filter size, and a quantity of hash functions.

22. The method of claim 20, further comprising:
receiving a data transmission based at least in part on the monitoring.

23. The method of claim 20, further comprising:
terminating the monitoring based at least in part on failure to receive the data transmission; and
entering a power saving mode based at least in part on the terminating.

24. The method of claim 20,
wherein the data object indicates a bloom filter size, a quantity of hash functions, or both, and
wherein the set of bit positions is based at least in part on the bloom filter size, the quantity of hash functions, or both.

25. The method of claim 20, wherein the comparison indicates that the first wireless communication device is to monitor for the data transmission by indicating that the first wireless communication device has a non-zero probability of being associated with one or more pending data transmissions.

26. The method of claim 20, further comprising:
receiving a second data object comprising a second bloom filter output; and
determining not to monitor for a second data transmission based at least in part on a second comparison between a second set of bit positions and the second bloom filter output, the second set of bit positions being based at least in part on the authentication key, and the second comparison indicating that the first wireless communication device has a zero probability of being associated with the second data transmission.

27. The method of claim 20,
wherein the first wireless communication device comprises a station (STA) and the second wireless communication device comprises an access point (AP).

28. A method for wireless communications by a second wireless communication device, comprising:
transmitting a data object via one or more channels indicating a bloom filter output, the bloom filter output indicating that one or more first wireless communication devices of a plurality of first wireless communication devices is to monitor for data transmission; and
transmitting one or more data transmissions associated with the one or more first wireless communication devices based at least in part on the data object.

29. The method of claim 28, further comprising:
establishing a plurality of authentication keys with the plurality of first wireless communication devices; and
generating one or more respective bloom filter inputs associated with the one or more first wireless communication devices based at least in part on one or more respective authentication keys of the plurality of authentication keys and one or more respective randomization values,
wherein the bloom filter output is based at least in part on the one or more respective bloom filter inputs, a bloom filter size, and a quantity of hash functions.

30. The method of claim 29,
wherein the bloom filter output comprises one or more bit positions that are set to a value of 1 and that are different than one or more additional bit positions that are set to the value of 1 based at least in part on the one or more respective bloom filter inputs, the quantity of hash functions, and one or more randomized bit values.
